(19) United States
(12) Patent Application Publication
(10) Pub. No.: US 2018/0073675 A1
(43) Pub. Date: Mar. 15, 2018

(54) Ultimate Pinatero

(71) Applicant: Angel Mario Torres, Wylie, TX (US)

(72) Inventor: Angel Mario Torres, Wylie, TX (US)

(21) Appl. No.: 15/382,343

(22) Filed: Dec. 16, 2016

Related U.S. Application Data
(60) Provisional application No. 62/495,392, filed on Sep. 13, 2016.

(51) Int. Cl. F16M 13/02; F16M 11/20; F16M 11/24; A63H 37/00

(52) U.S. Cl. CPC F16M 13/02; F16M 11/2021; F16M 2200/024; F16M 11/24; A63H 37/00; F16M 11/2014

(57) ABSTRACT

A piñata holding device for holding a piñata may include a first support arm being substantially vertical and being rotatably connected to a support surface; and a second pivot arm to pivot with respect to the first support arm; and a third support arm connected to the second pivot arm to extend and hold the piñata.

### FIELD OF THE INVENTION

The present invention relates to holders and more particularly to a piñata holder.

### BACKGROUND

A piñata is a container often made of papier-mache, pottery, or cloth, and it is decorated, and filled with small toys or candy, or both, and then broken as part of a ceremony or celebration. Piñatas are commonly associated with Mexico. The idea of breaking a container filled with treats came to Europe in the 14th century, where the name, from the Italian pignatta, was introduced. The Spanish brought the European tradition to Mexico, although there were similar traditions in Mesoamerica, such as the Aztecs' honoring the birthday of the god Huitzilopochtli in mid December. According to local records, the Mexican piñata tradition began in the town of Acolman, just north of Mexico City, where piñatas were introduced for catechism purposes as well as to co-opt the Huitzilopochtli ceremony. Today, the piñata is still part of Mexican culture, the cultures of other countries in Latin America, as well as the United States, but it has mostly lost its religious character.

### SUMMARY

A piñata holding device for holding a piñata may include a first support arm being substantially vertical and being rotatably connected to a support surface; a second pivot arm to pivot with respect to the first support arm; and a third support arm connected to the second pivot arm to hold the piñata.

The first support arm may be connected to a mounting device.

The mounting device may be a mounting plate.

The first support arm may be connected to the pivot arm by a pivot plate.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a piñata holding device of the present invention;

FIG. 2 illustrates a cross-section of a first fastener of the present invention;

FIG. 3 illustrates a cross-section of the support arm of the present invention;

FIG. 4 illustrates a cross-section of another support arm of the present invention;

FIG. 5 illustrates a perspective view of another fastener of the present invention.

### DETAILED DESCRIPTION

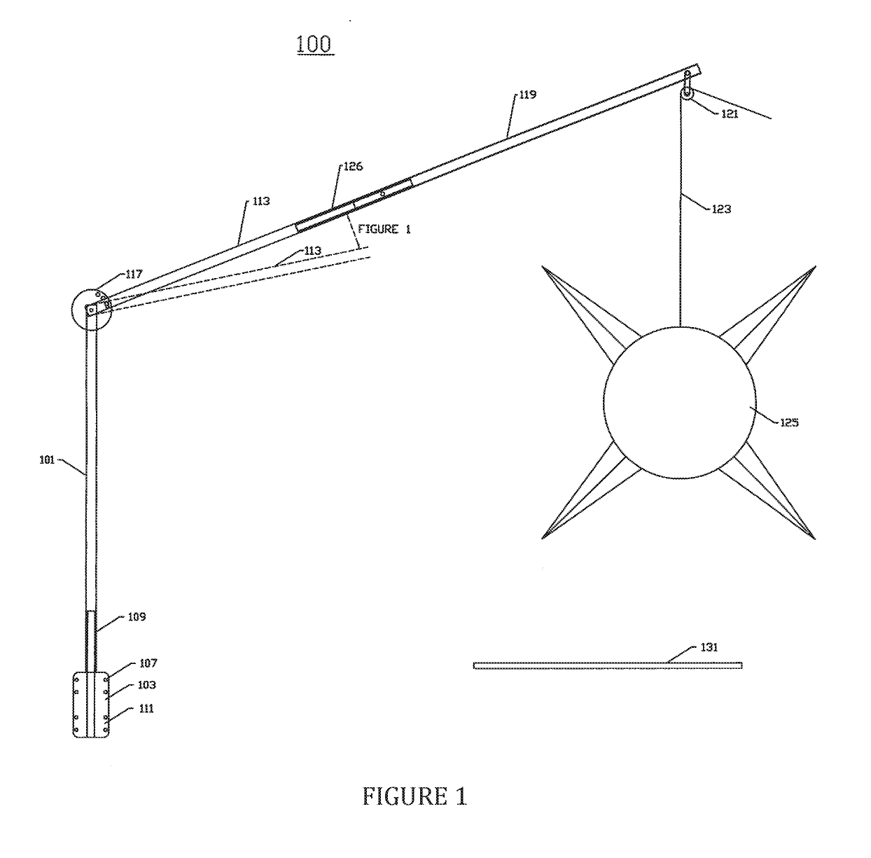

FIG. 1 illustrates the piñata holding device TOO of the present invention which may include a mounting device 103 which may be a mounting plate which may be a rectangular, round, oval or other appropriate shape and may be formed from metal, plastic, wood or other appropriate material.

The mounting device 103 may include a multitude of opposing apertures 107 which may be formed along the edge of the mounting device 103.

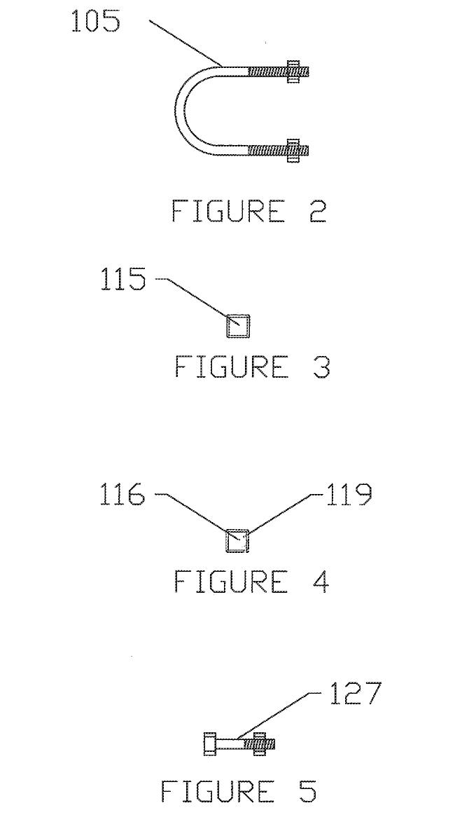

FIG. 2 illustrates a first fastener 105 which may be a U-shaped bracket having arms which cooperate with the apertures 107 to rotatably connect a first support arm 10I which may be secured substantially vertically (and rotates) and which may have a central aperture 115 (see FIG. 3) which may extend the length of the first support arm 101.

A movable/slidable or fixed connecting rod 109 may be positioned within the central aperture 115 to cooperate with the central aperture of another support arm to extend the length of and stabilize the support arm.

The first support arm 101 connected to a support surface 111; the support arm 101 may be pivotably connected to a second support arm 113 by a pivoting plate 117 to allow the second support arm 113 to pivot with respect to the first support arm 101 to change the angle of the second support arm 113 and to raise and lower the height of the piñata holding device 100 by cooperating with the aperture 116.

FIG. 1 illustrates the second support arm 113 pivoting between a first position and a second position, and the second support arm 113 may be connected to a third support arm 119 by the removable connecting rod 126 being positioned within the central aperture 115 of both the second support arm 113 and the third support arm 119.

The end of the third support arm 119 may include an aperture to cooperate with a shaft of a pulley 121 which may cooperate with a flexible cord 123 to suspend a piñata 125 which may be struck by a stick 131.

FIG. 3 illustrates an exemplary cross-section of the one of the first support arm 101 (rotatable), the second support arm 113 (pivoting) or the third support arm 119. FIG. 3 illustrates the central aperture 115.

FIG. 4 illustrates the central aperture 116.

FIG. 5 illustrates a locking fastener 127 for the pivoting plate 117. The first support arm 101 may be connected to the second support arm 113 by a locking fastener 127. The second support rod 113 may be connected to the third support arm 119 by a locking fastener 127. Pulley 121 may be connected to the third support arm 119 by the locking fastener 127.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A pinata holding device for holding a pinata, comprising:
a first support arm being substantially vertical and being connected to a support surface;
a second support arm to pivot with respect to the first support arm;
a third support arm connected via an internal connection rod to the second support arm to hold the pinata; and
a pulley is connected to the third support arm distally from the internal connection rod and second support arm.

2) The pinata holding device for holding a pinata as in claim 1, wherein the support surface is a mounting device.

3) The pinata holding device for holding a piñata as in claim 2, wherein the mounting device is a mounting plate.

4) The piñata holding device for holding a piñata as in claim 1, wherein the first support arm is connected to the pivot arm by a pivot plate.

5) The piñata holding device for holding a piñata as in claim 1 wherein the third support arm extends the piñata distally from the first support arm.

6) The pinata holding device for holding a piñata as in claim 2, wherein the mounting device has at least two opposing apertures.

7) The pinata holding device for holding a piñata as in claim 2, wherein the mounting device has at least four opposing apertures.

8) The pinata holding device for holding a piñata as in claim 2, wherein the mounting device has at least six opposing apertures.

9) The pinata holding device for holding a piñata as in claim 2, wherein the mounting device has at least eight opposing apertures.

10) The pinata holding device for holding a piñata as in claim 2, wherein the mounting device has at least two opposing apertures, and the at least two opposing apertures can be utilized with a U-shaped fastener to secure the first support arm in a vertical position.

11) The pinata holding device for holding a piñata as in claim 3, wherein the mounting plate is metal.

12) The pinata holding device for holding a piñata as in claim 3, wherein the mounting plate is wood.

13) The pinata holding device for holding a piñata as in claim 3, wherein the mounting plate is plastic.

14) The pinata holding device for holding a piñata as in claim 4, wherein the pivot plate connects to the first support arm via a fastener.

15) The pinata holding device for holding a piñata as in claim 4, wherein the pivot plate connects to the second support arm via a fastener.
